(19) United States
(12) Patent Application Publication
(10) Pub. No.: US 2002/0009254 A1
(43) Pub. Date: Jan. 24, 2002

(54) High switching speed digital faraday rotator device and optical switches reduced cross talk and state sensing capability

(76) Inventor: Zhifeng Sui, Fremont, CA (US)

Correspondence Address: Bo-In Lin, 13445 Mandoli Drive, Los Altos Hills, CA, 94022, US

(21) Appl. No.: 09/894,650

(22) Filed: Jun. 27, 2001

Related U.S. Application Data
(60) Provisional application No. 60/220,386, filed on Jul. 24, 2000.
(60) Provisional application No. 60/267,283, filed on Feb. 7, 2001.

(51) Int. Cl. G02B 6/35; G02B 6/27

(52) U.S. Cl. 385/16; 385/11

(57) ABSTRACT

Cross talk reduction is essential in all-optical switches. This invention utilizes a series of polarization rotating devices to remove cross-talking leakage lights away from the main optical path. The designs of both 1×2 and 2×2 polarization-independent optical switches having significantly reduced cross talk are disclosed. Also, a method to construct bi-directional magneto-optical (MO) switches is introduced. The cross talk reduction scheme for the bi-directional MO switches can be further simplified. Furthermore, the current invention discloses a novel sensing mechanism where a magnetic field sensor is positioned nearby the magneto-optic crystal so that its magnetization state can be easily detected. The state of the optical switch can, therefore, be sensed at any given time.

This Application claims a priority date of Jul. 24, 2000 benefited from a previously filed Provisional Patent Application No. 60/220,386 filed on Jul. 24, 2000.

### BACKGROUND OF THE INVENTION

1. Field of the Invention

The invention relates generally to method and apparatus for optical signal transmission. More particularly, this invention relates to bi-stable polarization control method and apparatus for configuring high-speed optical switches.

2. Descriptions of the Prior Art

As more fiber optic network systems are installed for carrying out optical signal transmissions, a technical challenge is still faced by those of ordinary skill to provide optical switches with high switching speed and long term operation reliability. An optical network system typically incorporates one or more switches to direct the optical paths for transmitting the optical signal to the desired destinations. In addition to the general requirements of low insertion loss, small cross talk, high extinction ratio, low polarization-dependent loss, etc., increasingly there is a demand for optical switches that have a high switching speed and good long-term reliability. The switching speed and reliability requirements are particularly important for optical network systems that demand high performance and long-term reliable signal transmissions.

Most optical switches implemented with prior art technology use mechanical switches, which utilize moving parts for controlling the optical signal transmission through different paths. Due to the need to mechanically move the optical element(s), switching speed is very limited, typically in millisecond range. Furthermore, the moving part is susceptible to material fatigue and worn out of linkages, particularly to these components connected to the moving parts. Long-term reliability becomes a major problem for design, operation, and maintenance of the optical network signal transmission systems as that discussed by P. G. Hale and R. Kompfner, in a paper “Mechanical Optical-Fiber Switch,” Electron. Lett. 12, 388 (1976).

In order to overcome these difficulties, non-mechanical switches are implemented. The non-mechanical optical switches control the optical transmission paths of light by controlling the polarization state of a light by applying either magneto-optical (MO) or electro-optical (EO) control mechanism on the transmission of the light. In the case of using magneto-optic effect for controlling the switching operations, the typical device is composed of a soft Faraday rotator and an electromagnet. The magnetically soft Faraday rotator is located inside a cylindrical electromagnet that has coil windings around a soft magnet. Control of the magnetization state of the Faraday rotator is achieved by controlling the directions of the driving current in the coil. The drawback of this scheme is that it requires a continuous high current source to maintain the magnetization state in the Faraday rotator, resulting in high power consumption.

This problem can be alleviated by the more efficient, but sophisticated, electromagnet designs. Several prior art references discussed about these techniques, specifically in U.S. Pat. No. 5,048,937 entitled “Faraday Rotator Device and Optical Switch Containing same,” issued on Sep. 17, 1991 to Shigeru Takeda and Satoshi Makio. An article entitled “Non-mechanical optical switch for single-mode fibers” was published in Applied Optics, Vol. 21, No.23,4229-4234, 1982 by M. Shirasaki, H. Nakajima, T. Obokata, and K. Asama. Another article entitled “Magneto-optical 2×2 switch for single-mode fibers,” was published in Applied Optics, Vol.23, No.19,3272-3276, 1984, by M. Shirasaki, F. Wada, H. Takainatsu, H Nakajima, and K. Asama. Here, a different electromagnet using semi-hard magnetic core material instead of the conventional soft magnets combining with a driving current pulse with finite time duration reduces the need for a continuous power supply. However, the material properties of the semi-hard magnet has to be carefully optimized so that it is not too hard to drive, yet hard enough to sustain the required remnant state. Specific details can be referred to U.S. Pat. No. 5,627,924, entitled “Article Comprising a non-mechanical optical fiber switch,” issued on May 6, 1997 to S. Jin, I. Royer and T Tiefel. These devices however require complicated electromagnet design. Additionally, the devices are more expensive because sophisticated magnet with optimized material property has to be used.

Another difficulty faced by conventional optical switch is the cross talk between channels. All above-mentioned optical switches can be designed based on optical analyses to satisfy specifications providing tolerance ranges of different design parameters. However, when these designs are practically implemented, cross talks are introduced due to imprecise polarization rotation caused by optical misalignment or variations in temperature, crystal thickness and wavelength, etc. For the purpose of maintaining signal integrity during data transmission, particularly for high bandwidth optical transmission systems, a robust mechanism to reduce cross talk is necessary. One method for reducing the cross talk is to remove the unwanted optical signals away from the main optical path. This can be accomplished by using a series of polarization rotating devices (PRDs).

Therefore, a need still exists in the art to provide a simple and compact switching device with high switching speed and long term reliability without requiring complicated electromagnets design and expensive materials such that these limitations and difficulties can be resolved. Another patent application filed by the applicant of this invention entitled “High Switching Speed Digital Faraday Rotator Device and Optical Switches Containing the Same” (Ser. No. 60/216,056 filed on Jul. 5, 2000 and Ser. No. 09/784,703 filed on Feb. 14, 2001) is hereby incorporated by reference in the patent application. The key to that patent application is the utilization of a semi-hard or hard magneto-optical crystal in the Faraday rotator instead of the soft magneto-optical crystal used in the prior arts. By using the rotator devices, the need for both a continuous current source and various complicated electromagnets designs is eliminated. However, in the meantime, a person of ordinary skill in the art still has a need to significantly reduce the cross talk in these switching devices for the purpose of maintaining data integrity in signal transmissions.

Furthermore, in practical application, it is often required to detect the state of optical switches in communication systems, especially at the time of power on. Since the above mentioned magneto-optic switches do not provide the capability for detecting state of the switches at power on, there is still a need in the art for a new configuration and method for detecting the state of a switch to satisfy such requirements.

### SUMMARY OF THE PRESENT INVENTION

It is the object of the present invention to provide a new, compact non-mechanical, non-blocking and high speed optical switch to reduce cross talk and to provide state sensing capability. The first object is achieved by removing the unwanted lights away from the main optical path by using a series of polarization rotating devices (PRDs), such as the digital Faraday rotator device disclosed in the US patent application No. 60/216,056, or liquid crystal, or many EO crystals. The first PRD combining with a Wollaston prism splits the light beam into two: one carries the main optical intensity, while the other contains the leakage signal resulting from the imprecise polarization rotation. Subsequently, a second PRD is used to switch the polarization of the leakage signal into a state so that it is not able to merge into the main optical path in a later stage. More PRDs can be cascaded to further improve the effectiveness of the cross talk reduction in the expense of cost and complexity. Two design examples illustrating the working concept for both 1×2 and 2×2 switches are disclosed in this invention.

The above mentioned 1×2 and 2×2 MO switches, including the ones in U.S. patent No. 60/216,056, are all one directional switches. Bi-directional MO switches can be constructed by replacing the half wave-plate right before or after the switchable digital Faraday rotator with a high coercivity, fixed Faraday rotator. The cross talk reduction for the bi-directional switches is also disclosed in this invention.

The basic concept of sensing the sate of the magneto-optic switch is realized by detecting the magnetization-state of the Faraday rotator. Since the operation of a Faraday rotator generates magnetic flux at the crystal surfaces, a magnetic field sensor is placed near the Faraday rotator to sense the field direction to accurately determine the state of the magneto-optic switch.

These and other objects and advantages of the present invention will no doubt become obvious to those of ordinary skill in the art after having read the following detailed descriptions of the preferred embodiment that is illustrated in the various drawing figures.

### BRIEF DESCRIPTION OF THE DRAWINGS

FIG. 1: Schematic of a polarization independent 1×2 optical switch using Wollaston prism: (a) Side view, (b) Top view, (c) Polarization states in the case of switching from I→O1. All 3 polarization rotating devices are in a state of maintaining the incoming light polarization. (d) Polarization states in the case of switching from I→O2. All 3 polarization rotating devices are in a state of rotating the incoming light polarization by 90°.

FIG. 2: Schematic of a polarization independent 2×2 optical switch using Wollaston prism: (a) Side view, (b) Top view, (c) Polarization states in the case of switching from I1→O2, I2→O1. 15, 18, 22 maintains incoming light polarization. 18′ rotates polarization by 90°. (viewing from right hand side of each component), (d) Polarization states in the case of switching from I1→O1, I2→O2. 15, 18, 22 rotate incoming light polarization by 90°. 18′ maintains polarization state. (viewing from right hand side of each component)

FIG. 3: A reversible Faraday rotator: (a) architecture (b) polarization state changes for forward traveling light (c) polarization state changes for backward traveling light. FIG. 4: Schematic of a bi-directional MO switch: (a) Side view, (b) Top view, (c) Polarization states in the case of switching from I→O1. (looking at the right side of each component; solid line for light traveling forward from I→O1, dashed line for light traveling backwards from O1→I)

FIG. 5: Architecture of a 1×2 bi-directional MO switch design with cross talk reduction scheme.

FIG. 6: Architecture of a 2×2 bi-directional MO switch design with cross talk reduction scheme.

FIG. 7: Digital Faraday rotator device structure with a magnetic field sensor on the side.

### DETAILED DESCRIPTION OF THE METHOD

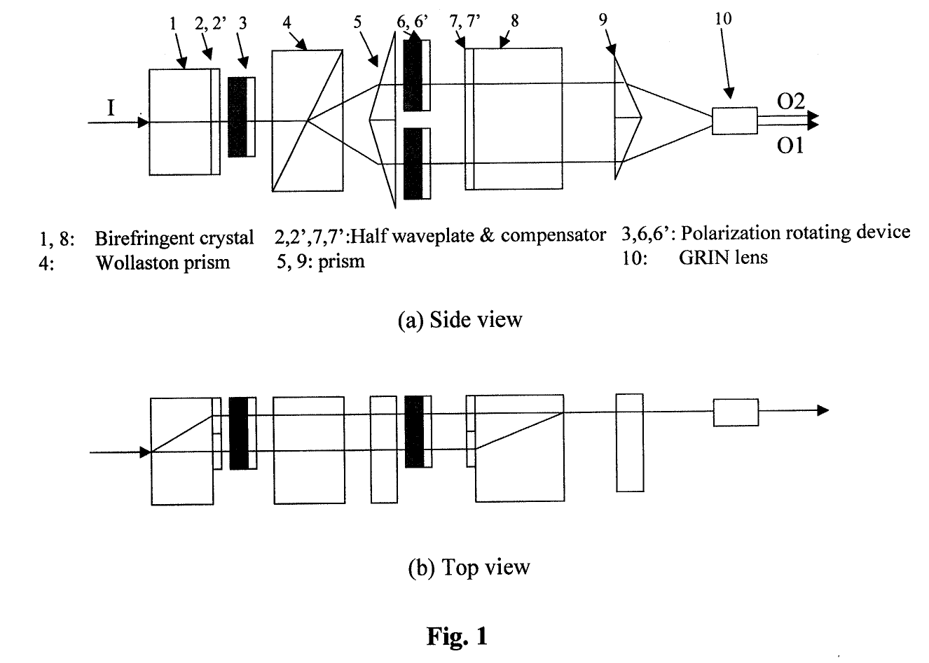

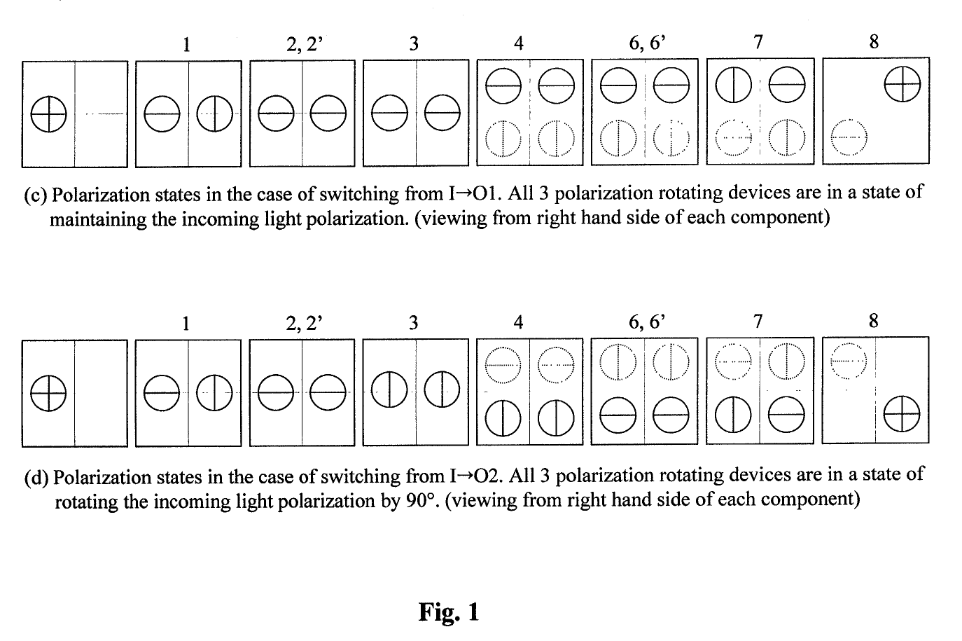

The basic concept of a polarization independent 1×2 optical switch is shown in FIGS. 1A and 1B as a cross sectional view and a top view respectively. Referring also to FIGS. 1C and 1D for polarization state changes as the beam passes through different components shown in FIGS. 1A and 1B as the Faraday rotator 3, 6 and 6′ are at two different magnetization states to carry out different polarization rotation operations. First, the light coming out of the fiber end is collimated using a GRIN lens (not shown). Then, the collimated light I passes through a birefringent crystal 1. The birefringent crystal 1 is used to split the incoming light into extraordinary (e) and ordinary (o) polarization beams as shown in FIGS. 1C and 1D. Next a half-wave plate 2 and a path compensator 2′ are used to modify the beams so that both beams have the same polarization parallel to each other as shown in FIGS. 1C and 1D. One of these two beam-components is then passed through a half-wave plate 2 and another beam component passes through a transparent glass plate 2′ such that the e-component and o-component have the same polarization. These two beam components are then projected to a digital Faraday rotator device 3. As shown in FIGS. 1A and 1B, three polarization rotating devices, e.g., three digital Faraday rotator devices 3, 6, and 6′ are used to construct the optical switch and, in the mean time, to eliminate the potential cross talk. The applicant of this invention discloses the digital Faraday rotators in the previously filed patent application (No. 60/216,056). To switch the light beam from port I to port O2 as shown in FIG. 1C, all three PRDs 3, 6 and 6′ are set to maintain the incoming beam polarization. Ideally, the two beams passing through PRD 3 do not change their polarization states. A Wollaston prism 4 is then used to guide the majority of the light into the upper two quadrants. In the meanwhile any leakage lights, from imprecise polarization rotation due to optical misalignment or variations in temperature, crystal thickness and wavelength, etc., are guided to the bottom two quadrants as shown in FIG. 1(c). The dashed lines in the figure indicate leakage lights. After passing through the next two PRDs 6, 6′, a set of half waveplates 7, 7′ and a birefringent crystal 8, the upper two beams are merged into the upper right quadrant, which is the output port O1. The bottom two beams, in the mean time, are diverged into the lower left quadrant and a location outside of all quadrants, respectively. Both of them will not enter either output port O1 or output port O2. Therefore, the cross talk is removed. To switch the light path from I to O2, all PRDs are set to a state, which rotates the incoming beam polarization by 90°. The rest of the working principle is very similar to the previous case, and the polarization state changes after each component are plotted in FIG. 1(d).

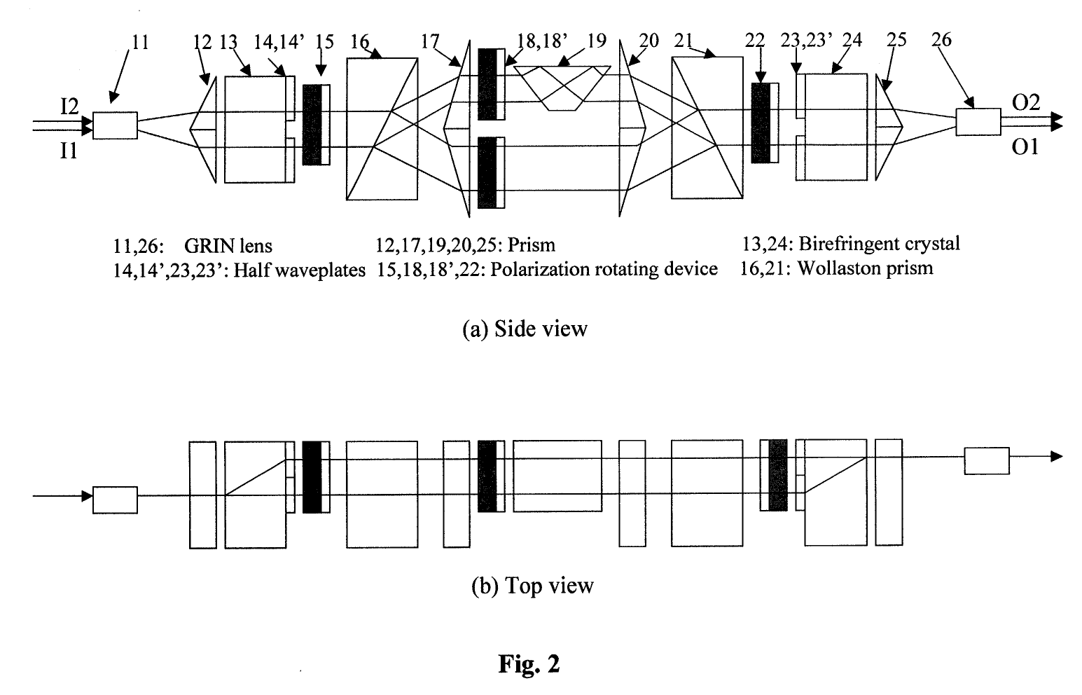

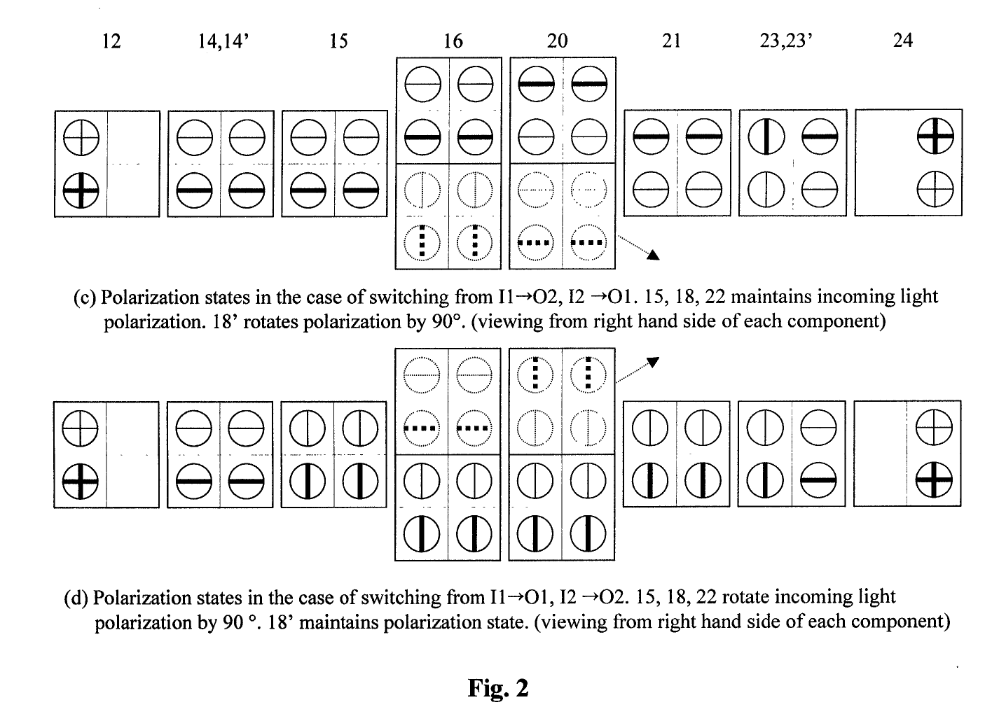

A 2×2 switch is designed using the similar concept. However, four PRDs are required instead of three. As shown in FIG. 2(a), two incoming beams I1 and I2 are spaced further apart by a GRIN lens 11 and a wedge prism 12. Each beam is then split into e and o beams by a birefringent crystal 13. A set of half waveplates 14, 14′ are then used to modify the four beams so that they all have the same polarization state as shown in FIGS. 2(c) and 2(d). Next, these four beams are projected into one of the two different paths by the combination of a PRD 15, a Wollaston prism 16 and a wedge prism 17, depending upon the state of the PRD 15. To switch the light beam from I1 to O2 and from I2 to O1, PRDs 15, 18, and 22 are set to maintain the polarization state of the incoming beams while PRD 18′ is set to change the incoming beam polarization by 90°. In this case, the majority of the lights are transmitted through the top four quadrants after 17. Only leakage lights go into the bottom four quadrants. PRD 18′ then rotates the polarization of the bottom leakage beams by 90°. The next Wollaston prism 21 then deflects these beams away from the main optical path so that the leakage lights is prevented from merging into either exit ports in a later stage. Therefore, the cross talk is eliminated. In the mean time, PRD 18 maintains the polarization state for the top four beams. However, prism 19 is used to swap the top and the bottom two beams in the top four quadrants. The wedge prism 20 and Wollaston prism 21 bring these four beams into the main optical path. After the following PRD 22, waveplates 23, 23′, birefringent crystal 24, wedge prism 25, and GRIN lens 26, the beams in top two quadrants are merged into output port 01 and the beams at the bottom are merged into output port O2 as shown in FIG. 2(c). The switching from I1 to O2 and from I2 to O1 is therefore completed. To switch from I1 to O1 and I2 to O2, PRDs 15,18, and 22 are set to rotate the incoming beam polarization by 90° while PDR 18′ maintains the incoming beam polarization. The rest of the switching operations are very similar to the previous case, and the switching process is illustrated in FIG. 2(d).

The above 1×2 and 2×2 switches both use Wollaston prisms to split or combine the beams. The Wollaston prisms can be easily replaced with birefringent crystals and the design concept remains the same. Also, the basic switching element does not have to be digital Faraday rotator. Any polarization control unit including liquid crystal, many EO crystals, etc. or combinations of many different kind of polarization control units can be used to replace the digital Faraday rotators without deviation from the design concept disclosed in the current invention.

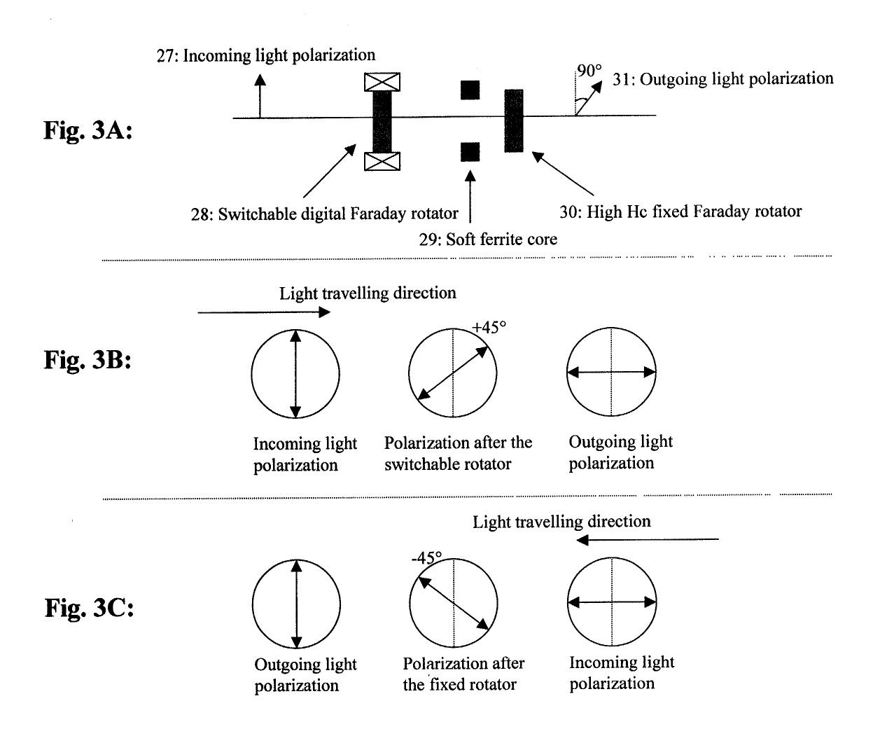

All above-mentioned MO switch designs, including the ones in the previously filed patent application No. 60/216,056, are described as with one directional light transmission only. The direction of light propagation is not reversible when the Faraday rotator is used because the Faraday rotator is an irreversible device for light propagation. A bi-directional switch can be achieved by replacing the conventional irreversible Faraday rotator with a reversible digital Faraday rotator configuration as shown in FIG. 3. The reversible digital Faraday rotator is composed of a switchable digital Faraday rotator 28 followed by a high coercivity, fixed Faraday rotator 30 in replacement of the half waveplate used in the conventional irreversible digital Faraday rotator. A shielding soft ferrite core 29 can be inserted between the two Faraday rotators so that when the switchable digital Faraday rotator 28 is switching, the stray magnetic field generated from the switchable Faraday rotator 28 is mostly absorbed by the soft ferrite core 29. The fixed Faraday rotator 30 will therefore not be affected by the switching and its magnetization state remains the same at all time. To further ensure the stability, the coercivity of the fixed Faraday rotator 30 is preferably increased to be at least twice as much as that of the first Faraday rotator. The operational principles for the reversible Faraday rotator are shown in FIGS. 3B and 3C. When a vertically polarized input light passes through the switchable Faraday rotator 28, the polarization is rotated by 45° clockwise as shown in FIG. 3B. After passing through the second fixed Faraday rotator 30, the polarization continues to rotate by another 45° clockwise so that the final output light polarization 31 is in the horizontal direction. The reverse process is achieved for a horizontally polarized light transmitted into the output port 31 as shown in FIG. 3C. After passing through the fixed Faraday rotator 30, the polarization is adjusted to a direction pointing to 45° count-clockwise, which is different from a polarization state as the light transmitted in the forward direction. However, after passing through the switchable Faraday rotator 28, the polarization rotates back to the vertical direction. The light propagation through the optical switch is now reversible when this design arrangement is implemented and the optical switch can be utilized as reversible optical switch for bi-directional applications.

A bi-directional one-by-two optical switch architecture is shown in FIG. 4. The reversible Faraday rotator is used instead of the conventional irreversible Faraday rotator. FIG. 4C shows the polarization state of each component when this bi-directional 1×2 switch is set to transmitting light from input port I to output port O1. At this state, if the light travels backwards from O1 to I, polarization state remains the same as that of the light traveling forward for most of the components, except the fixed Faraday rotator 36. The polarization after the fixed Faraday rotator 36 rotates the polarization by 45° counter-clockwise instead of 45° clockwise at the same location when the light travels in the forward direction. However, after passing through the switchable Faraday rotator 34, the polarization state reverses back to the same state as for the case with forward traveling light. Therefore, with the two Faraday rotators placed adjacent to each other, the switch becomes bi-directional.

The similar concept can be applied to the bi-directional MO switch family in general, which includes any switch dimensions such as 1×1, 1×2, 2×2 and even higher dimensions. The key is the use of reversible Faraday rotator instead of the conventional irreversible Faraday rotator.

The cross talk reduction scheme for the bi-directional switch is similar to that of the one directional switch as shown in FIGS. 1 and 2. As long as the reversible Faraday rotator replaces the irreversible Faraday rotator, the above mentioned cross talk reduction technique can be directly used for the bi-directional switches. However, as described below, the implementation for the bi-directional switch can be further simplified.

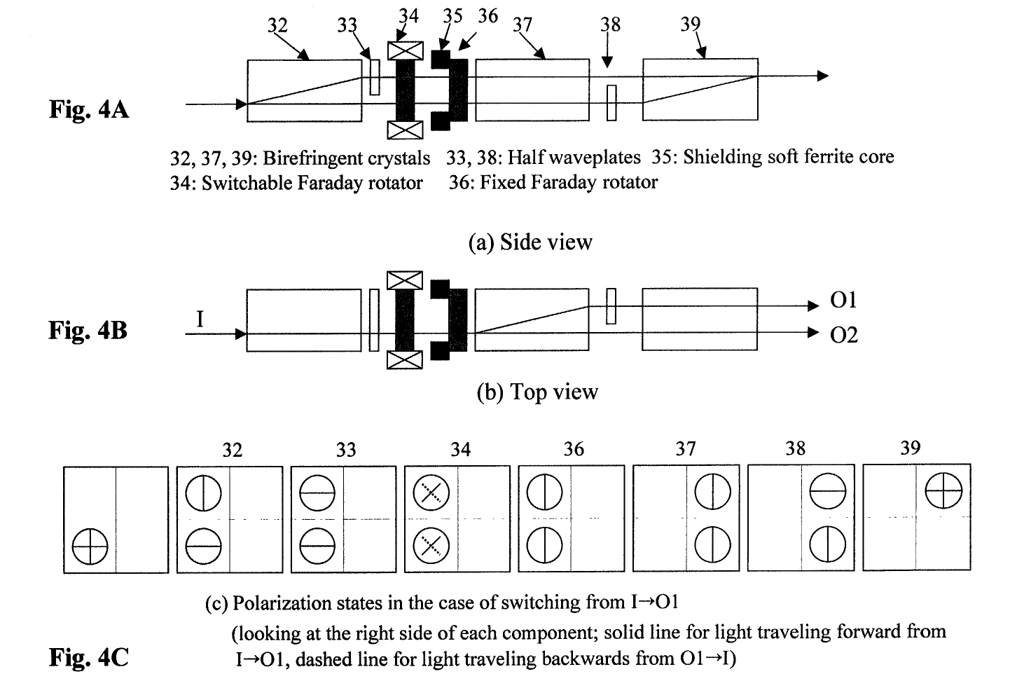

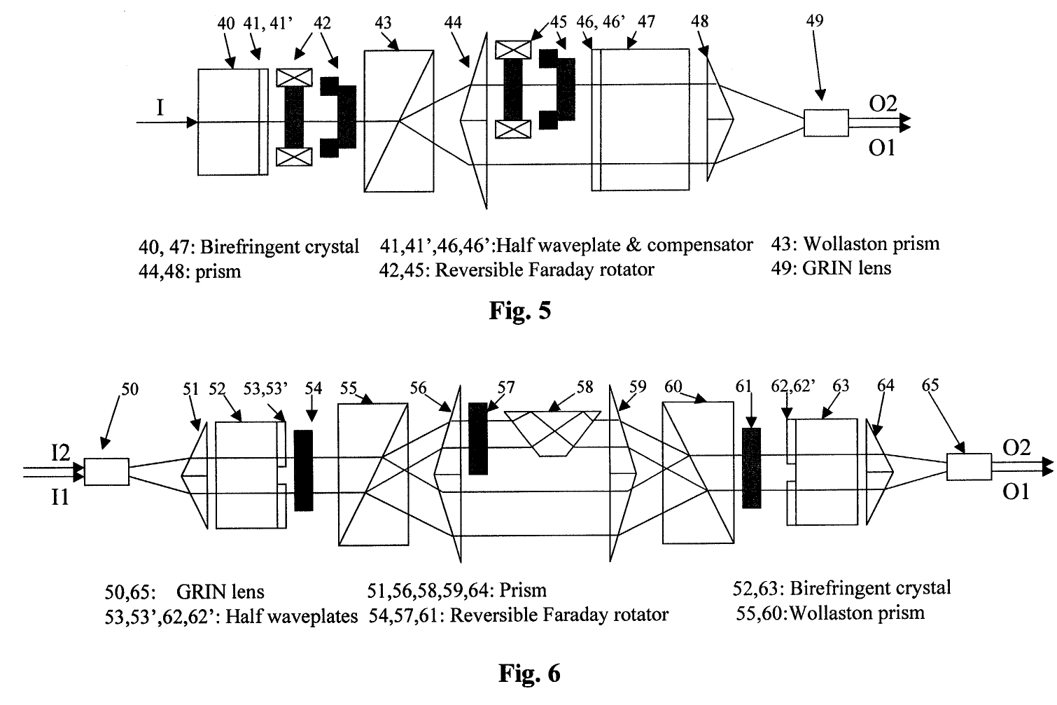

Since the reversible digital Faraday rotator contains two separate 45° MO crystals, it rotates the incoming light polarization by either 0° or 90° depending upon the magnetization states of the two crystals. For the 020 case, if the first MO crystal rotates the polarization by +45°, the second crystal must rotate the polarization by the same amount, but in the opposite direction at −45°. Since the two crystals have very similar optical properties, any imprecise polarization rotation caused by temperature or wavelength changes will be compensated by itself, which means the 0° rotation is very precise. Therefore, when the reversible digital Faraday rotator is in the state of rotating polarization by 0°, no leakage light will be generated after the following Wollaston prism. As a consequence, no PRD is needed in the branch which otherwise includes the cross-talking light signal. The implementation of the cross talk reduction scheme is therefore simplified. A 1×2 bi-directional switch with simplified cross talk reduction is shown in FIG. 5. Comparing to FIG. 1a, the PRD 6′ is removed because the design here assumes that the PRD 6 (or PRD 45 in FIG. 5) contains the light path which has the same polarization state as the one right before the first PRD 3 (or PRD 42 in FIG. 5). Similarly, a 2×2 design example is shown in FIG. 6. Again, comparing to FIG. 2a, either PRD 18 or 18′ can be removed depending upon which path contains the cross-talking signal when the first PRD 3 is in the 0° state.

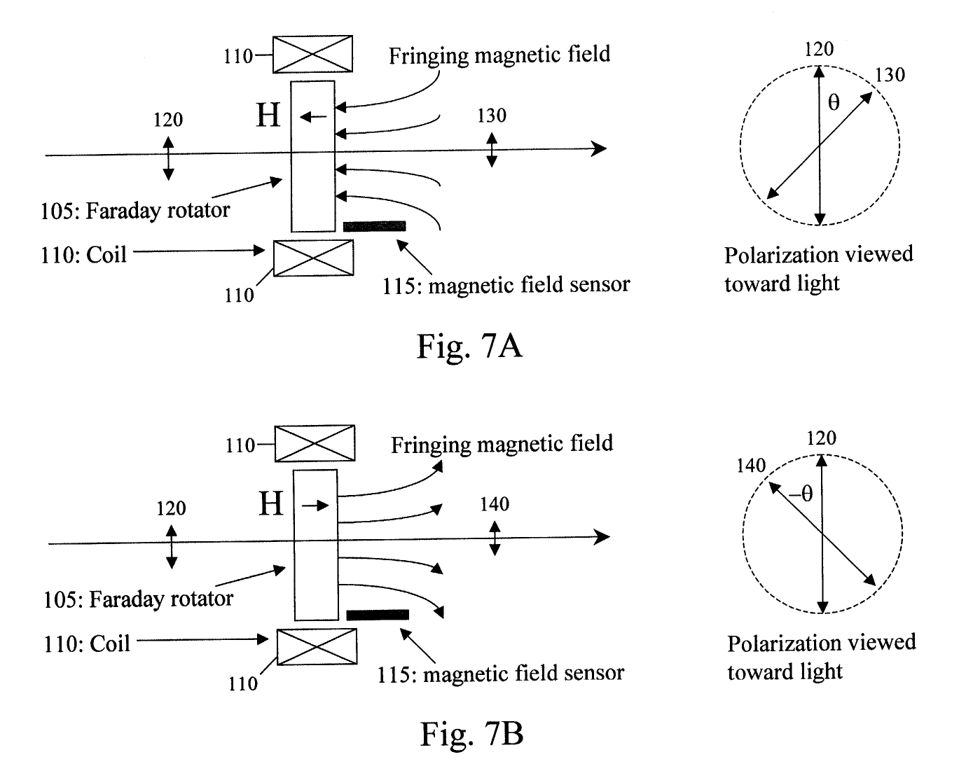

In order to detect the magnetization state of the Faraday rotator, a magnetic field sensor such as Hall sensor, magneto-resistive (MR) sensor, or giant magneto-resistive (GMR) sensor, etc., can be used to detect the magnetic fringing field generated from the crystal of the Faraday rotator. As shown in FIG. 7A and FIG. 7B, the sensor 115 is positioned very close to the crystal surface to achieve adequate signal output, yet, the sensor 115 is placed away from the main optical axis in order not to block the transmission of the light beams.

When the pulsed current passes through the coil winding 110 around the magneto-optic crystal 105, it generates a pulsed magnetic field and the direction of the field is towards left inside the coil. If the peak magnitude of the pulsed magnetic field exceeds the remanence coercivity of the magneto-optic crystal, the direction of the magnetization of the crystal is shown in FIG. 7A. The polarization 120 of the light passing through the said crystal is rotated by an angle θ with respect to that of incoming light. The direction of the fringing field generated by the said crystal is shown in FIG. 7A when the current in the coil goes to zero. When the opposite polarity pulsed current passing through the coil 110 is used, the polarization 120 of the light passing through the said crystal is rotated by an angle −θ with respect to that of incoming light. The direction of the remnant field generated by the said crystal is shown in FIG. 7B.

Therefore, the sensor is employed to generate two discernible output levels when the magneto-optic crystal is at two different states. The magnetization direction in the Faraday rotator is then determined based on the output levels provided by the sensor. The same sensor structure can be used in any magneto-optic switches using digital Faraday rotator. Detection of the state of a switch is therefore achieved through the sensing and determination of the magnetization direction of the Faraday rotator.

Although the present invention has been described in terms of the presently preferred embodiment, it is to be understood that such disclosure is not to be interpreted as the limit. Various alterations and modifications will no doubt become apparent to those skilled in the art after reading the above disclosure. Accordingly, it is intended that the appended claims be interpreted as covering all alterations and modifications as fall within the true spirit and scope of the invention.

I claim:

1. A method for configuring an optical switch for transmitting a main optical signal along a main optical path with a leakage optical signal comprising:
an optical path separating means for directing said leakage optical signal to transmit along a separate optical path away from said main optical signal path.

2. The method of claim 1 further comprising a step of:
employing a polarization rotation means for generating a state of polarization of said leakage optical signal for preventing said leakage optical signal from reaching an exit port of said main optical signal.

3. The method of claim 1 wherein:
said step of employing an optical path separating means comprising a step of employing a Wallaston prism.

4. The method of claim 2 wherein:
said step of employing an optical path separating means comprising a step of employing a birefringent crystal.

5. The method of claim 1 wherein:
said step of employing polarization rotation means comprising a step of employing a digital Faraday rotator.

6. The method of claim 1 wherein:
said step of employing polarization rotation means comprising a step of employing a digital Faraday rotator and a half-wave plate.

7. The method of claim 1 wherein:
said step of employing an optical path separating means comprising a step of employing a polarization-dependent optical path separating means for transmitting said main optical signal having a first polarization state along said main optical path and directing said leakage optical signal having a second polarization away from said main optical path.

8. The method of claim 1 further comprising a step of:
employing a single fiber pigtail for receiving an input optical signal and a double fiber pigtail for projecting an output optical signal for configuring said optical switch as a 1×2 optical switch.

9. The method of claim 1 further comprising a step of:
employing a double fiber pigtail for receiving two input optical signal s and a double fiber pigtail for projecting two output optical signals for configuring said optical switch as a 2×2 optical switch.

9. The method of claim 1 further comprising a step of:
employing a reversible polarization rotation means for configuring a reversible switch.

10. The method of claim 9 wherein:
said step of employing a reversible polarization rotation means further comprising a step of employing a switchable digital Faraday rotator and a fixed Faraday rotator for configuring said reversible switch.

11. The method of claim 10 wherein:
said step of employing a switchable digital Faraday rotator and a fixed Faraday rotator for configuring said reversible switch further comprising a step of employing said fixed Faraday rotator with a magnetic coercivity at least of double magnetic coercivity of said switchable Faraday rotator.

12. The method of claim 10 wherein:
said step of employing a switchable digital Faraday rotator and a fixed Faraday rotator further comprising a step of inserting a magnetic-flux shielding means between said switchable Faraday rotator and said fixed Faraday rotator for shielding said fixed Faraday rotator from changes of magnetic flux of said switchable Faraday rotator.

13. The method of claim 1 further comprising a step of:
employing a state-of -polarization (SOP) detection means for detecting a state of polarization (SOP) of said polarization rotation means for monitoring the state of operation of said optical switch.

14. The method of claim 5 further comprising a step of:
employing a magnetic-flux detector for detecting a state of polarization (SOP) of said digital Faraday rotator for monitoring a state of operation of said optical switch.

15. A method of configuring an optical switch comprising a step of:
employing a reversible polarization rotation means for configuring a reversible switch.

16. The method of claim 15 wherein:
said step of employing a reversible polarization rotation means further comprising a step of employing a switchable digital Faraday rotator and a fixed Faraday rotator for configuring said reversible switch.

17. The method of claim 16 wherein:
said step of employing a switchable digital Faraday rotator and a fixed Faraday rotator for configuring said reversible switch further comprising a step of employing said fixed Faraday rotator with a magnetic coercivity at least of double magnetic coercivity of said switchable Faraday rotator.

18. The method of claim 16 wherein:
said step of employing a switchable digital Faraday rotator and a fixed Faraday rotator further comprising a step of inserting a magnetic-flux shielding means between said switchable Faraday rotator and said fixed Faraday rotator for shielding said fixed Faraday rotator from changes of magnetic flux of said switchable Faraday rotator.

19. The method of claim 15 further comprising a step of:
employing a state-of -polarization (SOP) detection means for detecting a state of polarization (SOP) of said polarization rotation means for monitoring the state of operation of said reversible optical switch.

20. The method of claim 16 further comprising a step of:
employing a magnetic-flux detector for detecting a state of polarization (SOP) of said digital Faraday rotator for monitoring the state of operation of said reversible optical switch.

21. An optical switch for transmitting a main optical signal along a main optical path with a leakage optical signal comprising:
an optical path separating means for directing said leakage optical signal to transmit along a separate optical path away from said main optical signal path.

22. The optical switch of claim 21 further comprising:
a polarization rotation means for generating a state of polarization of said leakage optical signal for preventing said leakage optical signal from reaching an exit port of said main optical signal.

23. The optical switch of claim 21 wherein:
said optical path separating means comprising a Wallaston prism.

24. The optical switch of claim 21 wherein:
said optical path separating means comprising a birefringent crystal.

25. The optical switch of claim 21 wherein:
said polarization rotation means comprising a digital Faraday rotator.

26. The optical switch of claim 21 wherein:
said polarization rotation means comprising a digital Faraday rotator and a half-wave plate.

27. The optical switch of claim 21 wherein:
said optical path separating means comprising a polarization-dependent optical path separating means for transmitting said main optical signal having a first polarization state along said main optical path and directing said leakage optical signal having a second polarization away from said main optical path.

28. The optical switch of claim 21 wherein:
said optical switch is a 1×2 optical switching having a single fiber pigtail for receiving an input optical signal and a double fiber pigtail for projecting an output optical signal.

29. The optical switch of claim 21 wherein:
said optical switch is a 2×2 optical switch having a double fiber pigtail for receiving two input optical signals and a double fiber pigtail for projecting two output optical signals.

30. The optical switch of claim 21 wherein:
said polarization rotation means is a reversible polarization rotation means for configuring a reversible switch.

31. The optical switch of claim 30 wherein:
said reversible polarization rotation means further comprising a switchable digital Faraday rotator and a fixed Faraday rotator.

32. The optical switch of claim 30 wherein:
said fixed Faraday rotator having a magnetic coercivity of at least double magnetic coercivity of said switchable Faraday rotator.

33. The optical switch of claim 30 further comprising:
a magnetic-flux shielding means disposed between said switchable Faraday rotator and said fixed Faraday rotator for shielding said fixed Faraday rotator from changes of magnetic flux of said switchable Faraday rotator.

34. The optical switch of claim 21 further comprising:
a state-of -polarization (SOP) detection means for detecting the state of polarization (SOP) of said polarization rotation means for monitoring the state of operation of said optical switch.

35. The optical switch of claim 21 further comprising:
a magnetic-flux detector for detecting the state of polarization (SOP) of said digital Faraday rotator for monitoring the state of operation of said optical switch.

36. An optical switch comprising:
a reversible polarization rotation means for performing a reversible optical switch operation.

37. The optical switch of claim 36 wherein:
said reversible polarization rotation means further comprising a switchable digital Faraday rotator and a fixed Faraday rotator.

38. The optical switch of claim 36 wherein:
said fixed Faraday rotator having a magnetic coercivity at least double magnetic coercivity of said switchable Faraday rotator.

39. The optical switch of claim 36 further comprising:
a magnetic-flux shielding means disposed between said switchable Faraday rotator and said fixed Faraday rotator for shielding said fixed Faraday rotator from changes of magnetic flux of said switchable Faraday rotator.

40. The optical switch of claim 36 further comprising:
a state-of -polarization (SOP) detection means for detecting the state of polarization (SOP) of said polarization rotation means for monitoring the state of operation of said reversible optical switch.

41. The optical switch of claim 37 further comprising:
a magnetic-flux detector for detecting the state of polarization (SOP) of said digital Faraday rotator for monitoring the state of operation of said reversible optical switch.

42. A reversible optical polarization rotator comprising:
a switchable digital Faraday rotator and a fixed Faraday rotator.

43. The reversible optical polarization rotator of claim 42 wherein:
said fixed Faraday rotator having a magnetic coercivity of at least double magnetic coercivity of said switchable Faraday rotator.

44. The reversible optical polarization rotator of claim 42 further comprising:
a magnetic-flux shielding means disposed between said switchable Faraday rotator and said fixed Faraday rotator for shielding said fixed Faraday rotator from changes of magnetic flux of said switchable Faraday rotator.

45. The reversible optical polarization rotator of claim 42 further comprising:
a state-of -polarization (SOP) detection means for detecting the state of polarization (SOP) of said reversible polarization rotator.

46. The reversible optical polarization rotator of claim 45 wherein:
said SOP detection means further comprising a magnetic-flux detector for detecting the state of polarization (SOP) of said reversible polarization rotator.

47. A one-by-two optical switch with cross talk reduction comprising:
a first optical means for separating the input light into mutually orthogonal extraordinary e-component and ordinary o-component, and said first optical means further rotates the polarization angle from one of the two components by 90-degrees to align the two components into the same polarization state;
a first adjustable polarization rotation means for adjusting the polarization angle of said aligned components for generating a set of aligned polarization-adjusted components;
a second optical means for providing two alternative paths for the set of aligned polarization-adjusted components depending upon the polarization state of the aligned polarization-adjusted components;
a second set of adjustable polarization rotation means for further adjusting the polarization states of said alternative paths wherein one said polarization rotation means sets the polarization state of the main optical signal path in such a direction that it will enable the main optical signal to reach the desired exit port wherein the other said polarization rotation means sets the polarization state of the leakage signal path in such a direction that it will never reach any other exit ports; and
a third optical means for rotating the polarization angle by 90-degrees from one of said aligned polarization-adjusted components for producing mutually orthogonal output o-component and output e-component and for combining said output o-component with said output e-component as an output light for transmitting into either the first or the second output ports wherein the transmission of said output light to said first or second output ports are adjustable depending upon said polarization rotation made to said aligned polarization-adjusted components by said adjustable polarization rotation means.

48. The one-by-two optical switch with cross talk reduction of claim 47 wherein:
said first and second set of adjustable polarization rotation means comprising a Faraday rotator.

49. The one-by-two optical switch with cross talk reduction of claim 47 wherein:
said first optical means for separating said input light into mutually orthogonal extraordinary e-component and an ordinary o-component further including a birefringent crystal.

50. The one-by-two optical switch with cross talk reduction of claim 47 wherein:
said second optical means for providing two alternative paths for the set of aligned polarization-adjusted components further including Wollaston prism.

51. The one-by-two optical switch with cross talk reduction of claim 47 wherein:
said second optical means for providing two alternative paths for the set of aligned polarization-adjusted components further including birefringent crystal.

52. The one-by-two optical switch with cross talk reduction of claim 47 wherein:
said third optical means for modifying the polarization-state of said e-component and said o-component and for recombining the two components further comprising half waveplates for polarization adjustment and birefringent crystals for beam recombination.

53. A two-by-two optical switch with cross talk reduction comprising:
a first optical means for separating the first and the second input beams into respectively an extraordinary e1-component and e2-component, and respectively an ordinary o1-component and o2-component wherein each of said extraordinary e-components being orthogonal to said ordinary o-components, and said first optical means further rotates the polarization angle from two of the four components by 90° to align the four components into the same polarization state;
a first adjustable polarization rotation means for adjusting the polarization angle of said aligned four components for generating a set of four aligned polarization-adjusted components;
a second optical means for providing two alternative paths for said four aligned polarization-adjusted components depending upon the polarization state of the aligned polarization-adjusted components;
a second set of adjustable polarization rotation means for further adjusting the polarization states of said alternative paths wherein one said polarization rotation means sets the polarization state of the main optical signal path in such a direction that it will enable the main optical signal to reach the desired exit port wherein the other said polarization rotation means sets the polarization state of the leakage signal path in such a direction that it will never reach any exit ports;
a third optical means to converge said two alternative paths back into the single main optical path containing said aligned four polarization-adjusted components;
a forth adjustable polarization rotation means for further adjusting the polarization angle of said four aligned polarization-adjusted components for generating a set of four aligned further-polarization-adjusted components; and
a forth optical means for rotating two of the four said aligned further-polarization-adjusted components by 90° and then merging the ordinary o-components with the extraordinary e-components from the same original input light source to generate two output light beams and finally transmitting them into first and second output ports wherein the transmission of the merged output lights into said first and second output ports are adjustable depending upon the magnetization states of said adjustable polarization rotation means.

54. The two-by-two optical switch with cross talk reduction of claim 53 wherein:
said four adjustable polarization rotation means comprising a Faraday rotator.

55. The two-by-two optical switch with cross talk reduction of claim 53 wherein:
said first optical means for separating said first and a second beams into respectively an extraordinary e1-component and e2-component, and respectively an ordinary o1-component and o2-component further including a birefringent crystal.

56. The two-by-two optical switch with cross talk reduction of claim 53 wherein:
said first optical means for rotating two of the four said polarization components by 90-degrees further including half waveplates.

57. The two-by-two optical switch with cross talk reduction of claim 53 wherein:
said second optical means for providing two alternative paths for said four aligned polarization-adjusted components further comprising a Wollaston prism or a birefringent crystal.

58. The two-by-two optical switch with cross talk reduction of claim 53 wherein:
said third optical means to converge said two alternative paths back into the single main optical path further comprising a Wollaston prism or a birefringent crystal.

59. The two-by-two optical switch with cross talk reduction of claim 53 wherein:
said third optical means to converge said two alternative paths further comprising a prism in order to swap the top and the bottom two beams in the top four quadrants to ensure the correct beam combination in the later stage.

60. The two-by-two optical switch with cross talk reduction of claim 53 wherein:
said forth optical means for rotating two of the four said aligned further-polarization-adjusted components by 90° further comprising half waveplates.

61. The two-by-two optical switch with cross talk reduction of claim 53 wherein:
said forth optical means for merging the ordinary o-components with the extraordinary e-components from the same original input light source further comprising a birefringent crystal.

62. A reversible Faraday rotator comprising:
two magneto-optic crystal units having Faraday rotation effect wherein each said magneto-optic crystal unit rotates the light polarization by 45° and the said two magneto-optic crystal units are placed adjacent to each other.

63. The reversible Faraday rotator of claim 62 wherein:
the magnetization state of said first magneto-optic crystal unit is switchable wherein the magnetization state of said second magneto-optic crystal unit is fixed at all time by using high coercivity materials.

64. The reversible Faraday rotator of claim 62 wherein:
a soft ferrite core is inserted between the two said magneto-optic crystal units to shield the fixed magneto-optic crystal unit away from the magnetic field generated from the switchable magneto-optic crystal unit during switching.

65. A method for configuring a bi-directional magneto-optic switch comprising a step of:
replacing each of adjustable polarization rotating devices containing a conventional Faraday rotator and a half wave-plate used in one-directional magneto-optic switches with a reversible Faraday rotator.

66. The one-by-two optical switch with cross talk reduction of claim 47 wherein:
each of said adjustable polarization rotation means further comprising a reversible Faraday rotator so that the 1×2 switch functions as a bi-directional 1×2 switch.

67. The two-by-two optical switch with cross talk reduction of claim 53 wherein:
each of said adjustable polarization rotation means further comprising a reversible Faraday rotator so that the 2×2 switch functions as a bi-directional 2×2 switch.

68. The one-by-two switch with cross talk reduction of claim 66 wherein:
one of the two reversible Faraday rotators used for leakage light removal is omitted wherein the omitted reversible Faraday rotator is on the leakage light path when the first stage reversible Faraday rotator is at 0° state.

69. The two-by-two switch with cross talk reduction of claim 68 wherein:
one of the two reversible Faraday rotators used for leakage light removal is omitted wherein the omitted reversible Faraday rotator is on the leakage light path when the first stage reversible Faraday rotator is at 0° state.

70. A magnetization state sensing mechanism in a digital Faraday rotator comprising:
a magnetic field sensor on the side of the digital Faraday rotator.

71. The magnetization state sensing mechanism of claim 70 wherein:
said magnetic field sensor comprising a Hall sensor, a magneto-resistive (MR) sensor, or giant magneto-resistive (GMR) sensor.

72. A magneto-optical switches comprising:
a state sensing means comprising a magnetization state sensing device for sensing the polarization state of a polarization rotation means of said magneto-optical switch.
